(19) United States
(12) Patent Application Publication
(10) Pub. No.: US 2026/0362222 A1
(43) Pub. Date: Nov. 12, 2026

(54) ADVERTISING WIRELESS LOCAL AREA NETWORK L4S QUEUE INFORMATION TO STATIONS

(71) Applicant: Cisco Technology, Inc., San Jose, CA (US)

(72) Inventors: Robert Edgar Barton, Richmond (CA); Jerome Henry, Pittsboro, NC (US); Juan Carlos Zuniga, Montreal (CA); Binita Gupta, San Diego, CA (US)

(21) Appl. No.: 19/262,614

(22) Filed: Jul. 8, 2025

Related U.S. Application Data
(60) Provisional application No. 63/800,527, filed on May 6, 2025.

(51) Int. Cl. H04W 28/02; H04L 47/127; H04W 8/22; H04W 84/12

(52) U.S. Cl. CPC H04W 28/0268; H04L 47/127; H04W 8/22; H04W 84/12

(57) ABSTRACT

Techniques for addressing Low Latency, Low Loss, Scalable Throughput (L4S) congestion by providing enhancements to neighbor reports, beacon frames, and/or probe response frames to allow a wireless local area network (WLAN) Access Point (AP) to inform stations (STAs) about the L4S and non-L4S queue performance of nearby APs, which can allow the STA to roam to another AP, such as an AP that may have lower congestion or better L4S performance than the AP to which the STA is currently connected.

### PRIORITY CLAIM

This application claims the benefit of priority under 35 U.S.C. § 119 to U.S. Provisional Application No. 63/800,527, filed May. 6, 2025, the entirety of which is incorporated herein by reference.

### TECHNICAL FIELD

The present disclosure relates to wireless network equipment and services.

### BACKGROUND

Networking architectures have grown increasingly complex in communications environments, particularly wireless networking environments. For wireless local area networks (WLANs), Institute of Electrical and Electronics Engineers (IEEE) 802.11 specifications are working towards the definition of Low Latency, Low Loss, Scalable Throughput (L4S) mechanisms for implementation via WLAN access points (APs) and client devices or stations (STAs). Thus, there are new challenges and opportunities with regard to L4S solutions that can be provided for WLAN APs and STAs.

### BRIEF DESCRIPTION OF THE DRAWINGS

FIG. 1A is a diagram illustrating a system including a wireless local area network (WLAN) that may be implemented to advertise Low Latency, Low Loss, Scalable Throughput (L4S) queue information to wireless devices (STAs), according to an example embodiment.

FIG. 1B is a diagram illustrating example details for implementing L4S queues for multiple access categories (ACs), according to an example embodiment.

FIG. 2 is a diagram illustrating example details for an enhanced Neighbor Report element of an 802.11k Neighbor Report Response frame that can be used to advertise, to a wireless device (STA), queue information for one or more neighboring access points (APs) of a given AP, according to an example embodiment.

FIG. 3A is a diagram illustrating example details for an enhanced Beacon frame that can be used to advertise, to a wireless device (STA), queue information for one or more neighboring access points (APs) of a given AP, according to an example embodiment.

FIG. 3B is a diagram illustrating example details for an enhanced Probe Response frame that can be used to advertise, to a wireless device (STA), queue information for one or more neighboring access points (APs) of a given AP, according to an example embodiment.

FIG. 4 is a flowchart depicting a method according to an example embodiment.

FIG. 5 illustrates a hardware block diagram of a computing device configured to perform functions associated with operations discussed in connection with embodiments herein.

### DETAILED DESCRIPTION

### Overview

Embodiments herein provide techniques for addressing enhanced Low Latency, Low Loss, Scalable Throughput (L4S) congestion by providing an enhancement to the Institute of Electrical and Electronics Engineers (IEEE) 802.11k neighbor report (or to a Beacon or Probe Response), allowing an Access Point (AP) to inform wireless devices (also referred to herein as stations (STAs)) about nearby the L4S and non-L4S queue performance of nearby APs. Such queue performance information can allow a STA to roam to another AP, specifically, an AP that may have lower congestion or better L4S performance than the AP to which the STA is currently connected.

In some aspects, the techniques described herein relate to a method including: obtaining, by an access point (AP) in a wireless local area network (WLAN), queue information for one or more neighboring APs in the WLAN, wherein the queue information for each neighboring AP indicates performance of at least one of a plurality of Low Latency, Low Loss, Scalable Throughput (L4S) queues or a plurality of non-L4S queues maintained by each neighboring AP; and advertising, by the AP, the queue information for the one or more neighboring APs to at least one wireless device, wherein the advertising is performed via at least one of a neighbor report, a beacon frame, or a probe response frame.

### Example Embodiments

In a wireless local area network (WLAN), such as an IEEE 802.11 (Wi-Fi®) network, one or more wireless access points (APs) provide wireless Radio Frequency (RF) coverage over which one or more wireless devices (e.g., phones, wearable devices, tablets, etc.), often referred to as wireless client devices or stations (STAs) can connect to the APs in order to connect to one or more data networks (e.g., the public Internet, an enterprise network operated by an enterprise entity (e.g., a business, institution, university, etc.)), and/or the like.

Low Latency, Low Loss, Scalable Throughout (L4S) is an architecture and protocol suite defined by the Internet Engineering Task Force (IETF), such as through Request for Comments (RFCs) 9330, 9331, and 9332, with the purpose to provide low queuing latency, low packet loss, and scalable throughput control for all manner of real-time applications (e.g., streaming video, multiplayer games, and/or other real-time applications).

L4S is expected to quickly become the standard for dealing with latency-sensitive applications in networks, including wireless networks. L4S is built on the concept of one or more dedicated L4S queues that can be used for latency-sensitive traffic (including downstream or downlink (DL) traffic and upstream or uplink (UL) traffic), while other traffic can be managed by one or more non-L4S queues, also referred to herein as "classic" queues. A Dual Queue (DualQ or Dual-Q) Active Queue Management (AQM) mechanism or algorithm can be used to manage both L4S and non-L4S queues to ensure traffic of all types is handled properly.

In a WLAN with a high density of STAs using L4S enabled latency-sensitive traffic, the L4S queue(s) for downstream and upstream may quickly become consumed, which will trigger the Explicit Congestion Notification (ECN) codepoint marking mechanism in both directions (upstream and downstream) where all clients and servers begin to gradually lower their bitrate. When an AP’s L4S queue(s) becomes congested, all associated STAs will experience the outcome of congestion and be forced to lower their bitrate to ease congestion in upstream queue and pass congestion info to servers to reduce the rate.

While the mechanism to lower the bitrate works well, there is also an aspect of queue management that is to be considered. As an L4S queue begins to reach saturation (becomes congested), new STAs that roam onto the BSS may continue to exacerbate the problem by continuing to degrade performance of the L4S queue.

Embodiments herein provide techniques through which L4S and non-L4S ("classic") queue performance characteristics (broadly, queue performance information) can be monitored for multiple APs in a WLAN. L4S and non-L4S queue performance information for one or more APs that neighbor a given AP can be advertised by the given AP to STAs via enhanced IEEE 802.11k (referred to herein as "11k") neighbor reports, enhanced beacon frames, and/or enhanced probe response frames. Using the queue performance information, a given STA can determine to roam to another AP, specifically, an AP that may have lower congestion or better L4S performance than the AP to which the STA is currently connected.

Other enhancements to neighbor reports, beacon frames, and/or response frames can also be provided in accordance with embodiments herein, for example, to indicate L4S capability information of one or more neighboring APs (e.g., whether L4S is supported, L4S queue management support type/mechanism, L4S support direction, etc.) to a STA.

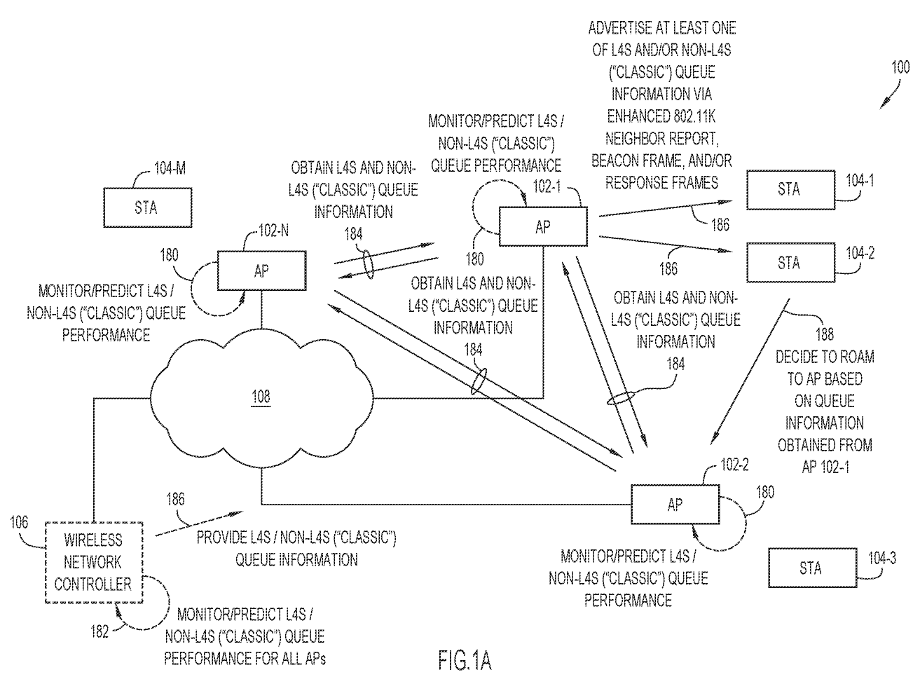

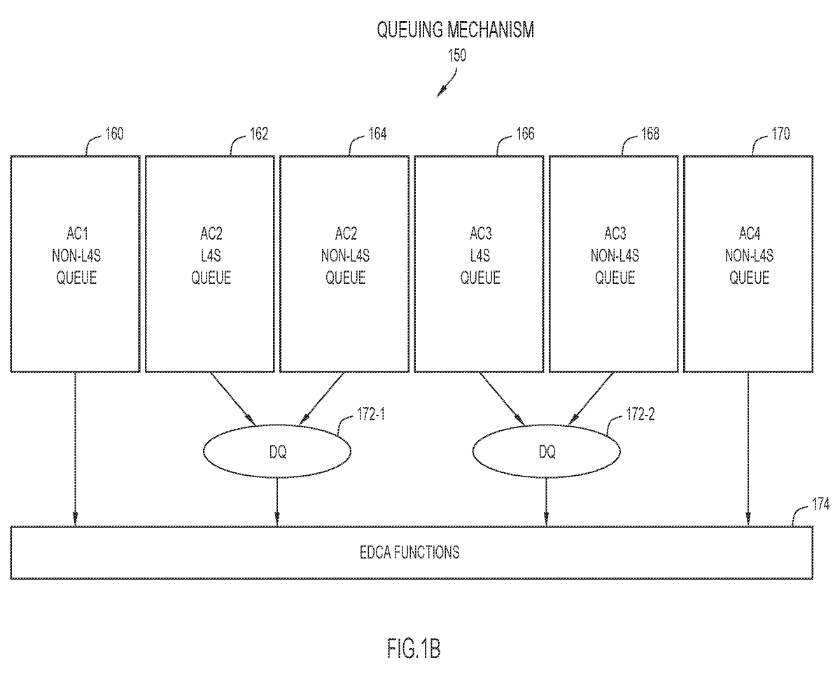

FIG. 1A is a diagram illustrating a system 100 including a wireless local area network (WLAN) that can be implemented to facilitate advertising L4S queue performance information to wireless devices (STAs), according to an example embodiment. Generally, system 100 illustrates a WLAN/802.11 network environment. In at least one embodiment, system 100 may include a number of WLAN APs, such as an AP 102-1, an AP 102-2, through an AP 102-N, and a number of wireless devices (STAs) that can exchange wireless communications with the APs, such as a STA 104-1, a STA 104-2, a STA 104-3, through a STA 104-M shown in FIG. 1A.

Also shown in FIG. 1A is a network 108. In some embodiments, system 100 may include a wireless network controller 106, sometimes referred to as a wireless LAN controller (WLC). Network 108 may be inclusive of any combination of wired and/or wireless networks through which communications can be exchanged between the APs 102-1 – 102-N and/or wireless network controller 106, if implemented.

Each AP 102-1 – 102-N can include any WLAN/802.11 hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) to facilitate WLAN RF coverage (for any WLAN/802.11 variant, such as 802.11ax (Wi-Fi 6/6E), 802.11be (Wi-Fi 7), 802.11bn (Wi-Fi 8), etc.) for system 100. In at least one embodiment, wireless network controller 106 (if implemented) can facilitate communications among APs 102-1 – 102-N and/or control/management of APs 102-1 – 102-N.

Each STA 104-1 – 104-M may be inclusive of any wireless device, may be considered any electronic device, etc. that initiates a connection or communication session with a corresponding network, and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, a cellular/WLAN enabled device, and/or any other device, component, element, or object capable of performing wireless voice, audio, video, media, or data exchanges within a system. Thus, a STA or wireless device may include any hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) in order to connect to one or more radio nodes/APs of one or more radio access networks(s) including WLAN/802.11 access networks (for any WLAN/802.11 variant).

FIG. 1B is a diagram illustrating example details for implementing L4S and non-L4S queues for any combination of APs 102-1 – 102-N and STAs 104-1–104-M of system 100. In at least one embodiment, each of APs 102-1 – 102-N and each of STAs 104-1 – 104-M can include a corresponding queuing mechanism, such as a queuing mechanism 150, as shown in FIG. 1B. However, in some embodiments, some of APs 102-1 – 102-N may not support L4S capabilities and/or some of STAs 104-1 – 104-M may not support L4S capabilities. Thus, it is to be understood that any combination of APs and/or STAs in WLAN environment may or may not support L4S capabilities.

FIG. 1B illustrates how an L4S queue may be implemented at the 802.11 MAC layer in at least one embodiment. In many cases, the L4S and non-L4S queues may share use of the existing Access Categories (ACs), however, other L4S queuing mechanisms can be envisioned.

An L4S queue is intended to be shallow – this is because the Explicit Congestion Notification (ECN) mechanism is designed to signal between sender-receiver (client-server) that congestion is detected and to slow down the bitrate, theoretically keeping packets out of a shallow L4S queue. In reality, however, this may not always be the case, and an L4S queue may function as designed when congestion builds up – that is, when the client-receiver bitrate is still not low enough, packets may be forced to pile up in the queue.

In many cases, the L4S and classic queues will likely share use of the existing ACs. For example, the queuing mechanism 150 can include a first AC non-L4S queue 160, a second AC L4S queue 162, a second AC non-L4S queue 164, a third AC L4S queue 166, a third AC non-L4S queue 168, and a fourth AC non-L4S queue 170. In some embodiments, the first AC is a background AC (AC_BK), the second AC is a best effort AC (AC_BE), the third AC is a video AC (AC_VI), and the fourth AC is a voice AC (AC_VO). The best effort AC and the video AC may include both a non-L4S (classic) queue and a L4S queue because the best effort AC and the video AC can manage a mix of L4S flows and non-L4S/classic flows. However, different ACs can have both a non-L4S queue and an L4S queue in some embodiments.

The queuing mechanism 150 may also include Distributed Queuing (DQ) switches, such as a DQ switch 172-1 and a DQ switch 172-2. The second AC L4S queue 162 and the second AC non-L4S queue 164 can both send queued traffic from the queues to DQ switch 172-1, and the third AC L4S queue 166 and the third AC non-L4S queue 168 can send the queued traffic from the queues to DQ switch 172-2. The queuing mechanism 150 also includes Enhanced Distributed Channel Access (EDCA) functions 174 for the first AC non-L4S queue 160, DQ switch 172-1, DQ switch 172-2, and the fourth AC non-L4S queue 170 to send queued traffic for subsequent transmission toward an AP. In at least one embodiment, the queuing mechanism 150 can be implemented at a Media Access Control (MAC) layer of a given STA or a given AP to enable control for L4S flow scheduling with low queuing delay and high output.

In at least one embodiment, each L4S queue can be a shallow queue and with low delay, so that each L4S queue can benefit from specific transmitting conditions. In some embodiments, frames in an L4S queue are transmitted using typical EDCA rules (e.g., according to EDCA rules for Arbitration Inter-Frame Spacing Number (AIFSN), Minimum Contention Window (CWmin), Maximum Contention Window (CWmax), retries, etc.).

In at least one embodiment, the queuing mechanism 150 can be implemented for handling both upstream (UL) and downstream (DL) traffic (generally referred to herein as a 'direction' of the traffic) for a given AP or STA; for example, two queuing mechanisms 150 can be implemented for a given AP or STA, for handling traffic/packets transmitted by an AP/STA and for handling traffic/packets received by the AP/STA. In at least one embodiment, the queuing mechanism 150 can implemented for handling only one of upstream (UL) or downstream (DL) traffic for a given AP or STA; for example, only one queueing mechanism 150 being implemented for the upstream direction or for the downstream direction.

In at least one embodiment, the queuing mechanism 150 can be implemented as an L4S Dual-Q AQM mechanism or algorithm. The L4S Dual-Q AQM mechanism or algorithm may provide for the ability to both mark L4S ECN codepoints, as well as to manage the allocation of resources for both the non-L4S ("classic") and L4S queues in the presence of congestion. In some embodiments, other queuing algorithms can be used including, but not limited to, Weighted Fair Queue (WFQ), Class Based Queueing (CBQ), and/or generic EDCA or Hybrid Coordination Function (HCF) Controlled Channel Access (HCCA).

Unlike generic low latency queues, L4S involves a mechanism whereby if congestion is detected, then ECN marking will start either at the STA or at the AP. In other words, L4S involves a queue that is managing traffic that is L4S marked. There are flows on the Internet which may be L4S flows and there are flows which are not L4S flows (non-L4S flows). Information is included in the IP header of the packets of the traffic to indicate whether it is associated with L4S traffic or not. Thus, an L4S queue is used to manage the L4S traffic.

Broadly, embodiments herein provide a queue monitoring system through which, during operation of a WLAN, L4S and non-L4S queue performance (assuming given APs support L4S queuing capabilities) can be monitored for APs in a WLAN, as generally shown at 180 of FIG. 1A for APs 102-1 through 102-N. In some embodiments, APs can perform their own monitoring of L4S/non-L4S queue performance (e.g., as shown at 180). In some embodiments, a network controller, such as wireless network controller 106, can perform the monitoring of L4S/non-L4S queue performance for APs, as generally shown at 182 of FIG. 1A. In some embodiments, the L4S/non-L4S monitoring can include predicting future states of L4S/non-L4S queues for a given AP.

Further, embodiments herein provide for obtaining, by a given AP, queue information for one or more APs that neighbor the given AP (referred to herein as 'neighboring APs'). The queue information may include any combination of queue performance information of the neighboring APs (e.g., queue performance information (including current and/or predicted states) for at least one of L4S queues and/or non-L4S queues maintained by a given neighboring AP) and/or L4S capability information of the neighboring APs (e.g., to indicate whether L4S is supported, to indicate L4S queue management support type/mechanism, to indicate L4S support direction such as upstream and/or downstream, etc.). In some embodiments, queue information can be obtained by a given AP from one or more neighboring APs (and vice versa) through one or more exchanges that can be performed between the given AP and the neighboring APs, as generally shown at 184 of FIG. 1A. The exchanges between APs can be performed via any combination of wired and/or wireless communications. In at least one embodiment, such inter-AP communications may be performed using Multi-AP Coordination (MAPC) techniques of IEEE 802.11bn. In some embodiments, for example, if wireless network controller monitors queue information 106, queue information for neighboring APs can be obtained by a given AP from (provided by) the wireless network controller 106, as generally shown at 186 of FIG. 1A.

Further, embodiments herein provide for advertising, by a given AP, queue information (e.g., performance information and capability information) for the one or more neighboring APs to at least one wireless device (STA) in which the advertising can be performed via at least one of an enhanced (IEEE 802.11k) neighbor report, an enhanced beacon frame, and/or an enhanced probe response frame, as generally shown at 186 of FIG. 1A. By obtaining such queue information, a STA can have a choice over the AP to which they may seek to roam under congestion conditions, for example, as shown at 188 of FIG. 1A with reference to STA 104-2 roaming from AP 102-1 to AP 102-2 based on queue information obtained from AP 102-1.

Consider more detailed features of various operations that can be performed via system 100 in accordance with embodiments herein.

### L4S and non-L4S Queue Monitoring

APs 102-1 – 102-N deployed the WLAN of system 100 can be enhanced to support new L4S and non-L4S queue monitoring operations. The queue monitoring operations may be referred to as a queue monitoring system. Broadly, monitoring operations performed for system 100 can include tracking, in time-series, how both L4S and non-L4S queues (for corresponding ACs) are performing for any combination of downstream and/or upstream queues of APs 102-1 – 102-N.

For example, monitoring operations performed in system 100, by APs 102-1 – 102-N and/or wireless network controller 106, can include recording the overall congestion / saturation of L4S/non-L4S queues, as well as the number of STAs currently experiencing a lower bitrate adaptation due to the L4S ECN mechanism (e.g., for STA(s) that received ECN messages in previous monitoring intervals). As part of the queue performance, the monitoring can include recording any combination of:
The current and/or average queue size and/or queue depth for L4S and non-L4S queues (and/or any other statistical queue metrics);
L4S Dual-Q AQM (or any other queuing mechanism/algorithm) performance parameters including, but not limited to, the L4S marking probability and queue drop probability for L4S and non-L4S queues, for both downstream and/or upstream L4S and non-L4S queues;
L4S-related queuing metrics, such as real-time delay and/or throughput performance of L4S queues; and/or
Timestamp information, which may indicate the Time Synchronization Function (TSF) time (sometimes referred to as 'time base') at which certain queue performance information is recorded.

In various embodiments, the queue performance information can be monitored/maintained at the APs 102-1 – 102-N and/or at the wireless network controller 106. In at least one embodiment, the queue performance information can be updated at regular intervals.

### Predicting Future L4S/non-L4S Queue States

As the APs 102-1 – 102-N and/or the wireless network controller 106 monitor/collect information about L4S and non-L4S queue performance, the APs / wireless network controller 106 can also predict future states of the queues in accordance with embodiments herein. In at least one embodiment, for example, using prediction logic such as Long Short-Term Memory (LSTM) models, or a shorter-term predictor/logic like the Lyapunov exponent, an AP can predict the likelihood of congestion of a given L4S and/or non-L4S queue in the near future based on recent observed metrics. Accordingly, the monitoring and predicting operations can be performed in conjunction with each other and/or in any order, as generally illustrated at 180 of FIG. 1A.

As one example, by using such prediction logic an AP may be capable of be able to predict that L4S congestion for a given L4S queue (for a given AC) is likely to occur within a period of time (e.g., a number of seconds, such as 20 seconds or any other period of time) and may cause a lowered bitrate effect (e.g., a percentage, such as 20% lower bitrate effect) on all STAs having traffic handled by the given L4S queue.

### APs Obtaining L4S and/or non-L4S Queue Information

The APs 102-1 – 102-N can exchange their L4S and/or non-L4S queue information with each other, including any combination of queue performance information (including current information and potentially predicted information) and/or queue capability information (e.g., whether L4S is supported, L4S queue management support type/mechanism, L4S support direction), as generally shown at 184 of FIG. 1A. In at least one embodiment, such inter-AP exchanges may be performed using MAPC techniques of IEEE 802.11bn. In some embodiments, for example, if the wireless network controller 106 monitors/predicts queue information, the queue information for neighboring APs can be obtained by a given AP from (provided by) the wireless network controller 106, as generally shown at 186 of FIG. 1A.

At this point, the APs will have a full report of the L4S and non-L4S queue performance and L4S capability information of all adjacent APs.

### Advertising L4S and/or non-L4S Queue Information to STAs

APs regularly provide IEEE 802.11k (11k) neighbor reports to STAs, giving them information on nearby candidate roaming APs. The report generally involves providing basic information, e.g., Basic Service Set Identifier (BSSID), operating channel, and BSS Load of one or more neighboring APs that will assist a STA in making a roam decision. IEEE 802.11k neighbor reports can be provided to a STA through solicited or unsolicited operations. For solicited operations, an AP can send an 11k neighbor report to a STA in a Neighbor Report Response frame upon obtaining a Neighbor Report Request frame from the STA. For unsolicited operations, an AP can send an 11k neighbor report to a STA, also in a Neighbor Report Response frame, upon triggering the transmission by the AP without obtaining a request for the report from a STA. Upon receiving an 11k neighbor report, it is up to the STA to ultimately decide if it will roam or not. However, currently the IEEE 802.11k neighbor report does not include any details about queue metrics (e.g., congestion metrics) of an AP.

Embodiments herein may provide an enhancement to the IEEE 802.11k Neighbor Report Response frame in order to include information in an enhanced 802.11k Neighbor Report element that can indicate queue information, which can include queue performance information of at least one of L4S and/or non-L4S queues of one or more neighboring APs and/or can indicate L4S queue capability information of one or more neighboring APs, in the form of an optional information subelement that can be added to the 802.11k Neighbor Report element.

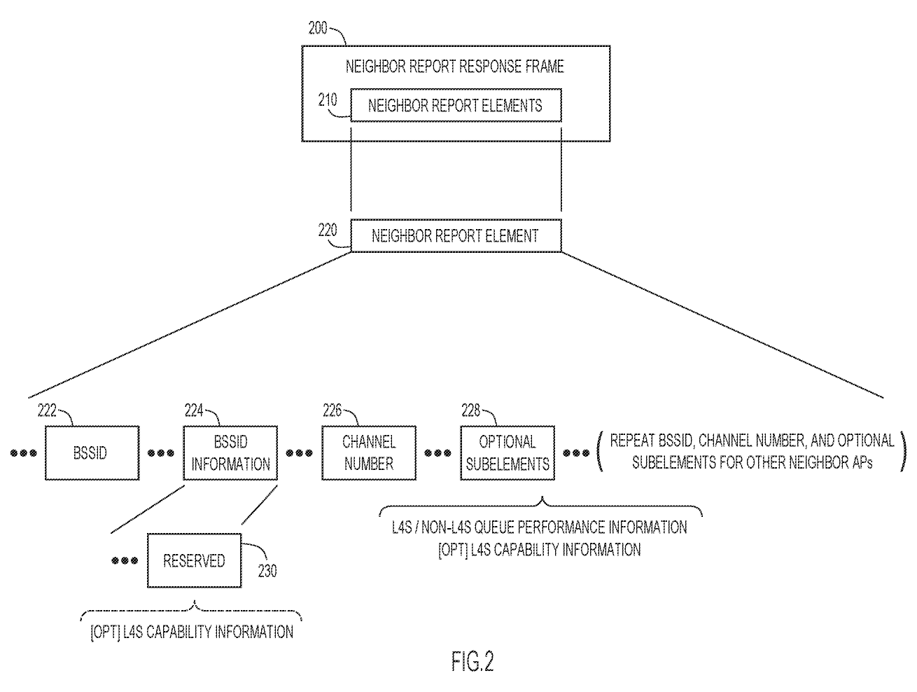

With reference to FIG. 2, FIG. 2 is a diagram illustrating example details for an enhanced Neighbor Report element 220 of a Neighbor Report Response frame 200 that can be used to advertise, to a wireless device (STA), queue information for one or more neighboring access points (APs) of a given AP, according to an example embodiment. The Neighbor Report Response frame 200 comprises various fields, but of relevance to the techniques presented herein, the Neighbor Report Response frame 200 is shown to include a Neighbor Report Elements field 210 that can include an enhanced Neighbor Report element 220. The enhanced Neighbor Report element 220 can be referred to herein as an enhanced neighbor report, an enhanced 802.11k neighbor report, or variations thereof.

The enhanced Neighbor Report element 220 comprises various fields, but of relevance to the techniques presented herein, the enhanced Neighbor Report element 220 includes, for each neighboring AP of a given AP (sending the Neighbor Report Response frame), a BSSID subfield 222 that contains the BSS of the neighboring AP, a BSSID Information subfield 224 that contains service information of the neighboring AP, a Channel Number subfield 226 that identities the channel of the neighboring AP (BSS), and an Optional Subelements subfield 228 that includes L4S and/or non-L4S queue information for the neighboring AP, including L4S and/or non-L4S queue performance information (upstream and/or downstream) and/or L4S capability information for the given neighboring AP. The BSSID, Channel Number, and Optional Subelements subfields can be repeated within the enhanced Neighbor Report element 220 for each neighboring AP of a given AP.

In various embodiments, queue performance information included in the enhanced Neighbor Report element 220 can include, for a given neighboring AP, the current and/or average queue size/queue depth for L4S and non-L4S queues (and/or any other statistical queue metrics); L4S Dual-Q AQM (or any other queuing mechanism/algorithm) performance parameters including, but not limited to, the L4S marking probability and/or queue drop probability for L4S and/or non-L4S queues, for downstream and/or upstream L4S and non-L4S queues; L4S and/or non-L4S queue congestion prediction information; L4S-related queuing metrics, such as real-time delay and/or throughput performance of L4S queues; and/or timestamp information, which may indicate the TSF of the neighboring AP converted into the current TSF of the AP transmitting the Neighbor Report Response frame 200. Including such timestamp information in queue performance metrics can enable a STA to determine how recent or 'fresh' the queue performance information is for a given neighboring AP.

As noted herein, the queue performance information for a neighboring AP can indicate performance of downstream and/or upstream queues at the neighboring AP. The queue performance information can reflect current conditions, predicted conditions (with a target time), or both. When the enhanced 802.11k Neighbor Report is issued/advertised by a given AP, STAs are given information which will help them make a roaming decision based on an AP’s L4S and non-L4S queue performance, L4S capabilities, as well as the likelihood of future congestion using prediction information that can be included in the enhanced 802.11k Neighbor Report.

In one embodiment, this enhanced 802.11k Neighbor Report element can be provided at a periodic interval and/or in response to a request from the STA (e.g., in response to receiving a Neighbor Report request from the STA). In another embodiment, the enhanced 802.11k Neighbor Report element can be unsolicited, and can be provided to a STA when a given AP predicts that the congestion state for this STA (for its L4S traffic) will soon exceed or satisfy a configurable threshold. In a Multi-Link Operation (MLO) context, a given AP can also provide the enhanced Neighbor Report when another link provides better L4S conditions than the current link on which a given STA is receiving L4S traffic.

In at least one embodiment, as noted above, the enhanced 802.11k Neighbor Report can include an L4S capability indication of whether a neighboring AP supports the L4S queuing capability and the L4S queuing algorithm or mechanism that is supported by the neighboring AP, such as Dual-Q AQM support, WFQ support, CBQ support, EDCA, or HCCA support. Thus, the L4S capability signaling for a neighboring AP can include an indication of:
L4S Support – to indicate whether a neighboring AP supports specific handling for L4S flows (e.g., queuing mechanism 150 or the like);
L4S Queue Management Support – to indicate the specific L4S queue management type/mechanism supported by the neighboring AP (e.g., Dual-Q AQM, WFQ, CBQ, EDCA, or HCF); and
L4S Support direction - indicates whether L4S specific handling is provided for downstream/DL traffic, upstream/UL traffic, or both.

The enhanced Neighbor Report element 220 can be augmented add the L4S capability indications for a neighboring AP using any combination of a Reserved bits subfield 230 of the BSSID subfield 224 and/or the Optional Subelements subfield 226, as illustrated in FIG. 2.

In some embodiments, an AP can advertise queue information, which can include queue performance information of at least one of L4S and/or non-L4S queues of the neighboring APs and/or can indicate L4S queue capability information of the neighboring APs via an enhanced Beacon frame and/or an enhanced Probe Response frame.

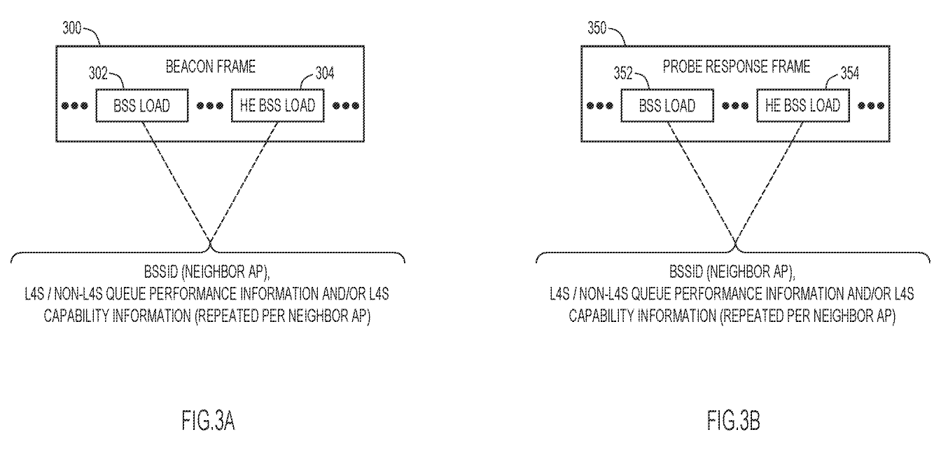

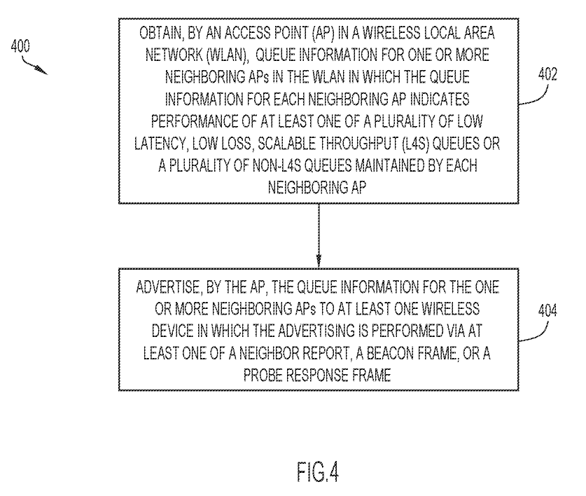

FIG. 3A is a diagram illustrating example details for an enhanced Beacon frame 300 that can be used to advertise, to a STA), queue information for one or more neighboring APs of a given AP, according to an example embodiment. The enhanced Beacon frame 300 comprises various fields, but of relevance to the techniques presented herein, the enhanced Beacon frame can include a BSS Load subfield 302 that typically includes BSS load information for a given AP (transmitting a Beacon frame) and a High Efficiency (HE) BSS Load subfield 304 that typically includes HE BSS load information for the given AP.

In some embodiments, one of the BSS Load subfield 302 or the HE BSS Load subfield 304 can be extended to include a BSSID of a given neighbor AP and queue information of the neighbor AP, including L4S / non-L4S queue performance information and/or L4S capability information for the neighbor AP. The BSSID and queue information can be repeated for a number of neighbor APs of the given AP transmitting the enhanced Beacon frame. In some embodiments, a new subfield can be defined for the enhanced Beacon frame 300 in order to advertise queue information for one or more neighbor APs.

FIG. 3B is a diagram illustrating example details for an enhanced Probe Response frame 350 that can be used to advertise, to a STA, queue information for one or more neighboring APs of a given AP, according to an example embodiment. The enhanced Probe Response frame 350 comprises various fields, but of relevance to the techniques presented herein, the enhanced Beacon frame can include a BSS Load subfield 352 that typically includes BSS load information for a given AP (transmitting a Probe Response frame) and an HE BSS Load subfield 354 that typically includes HE BSS load information for the given AP.

In some embodiments, one of the BSS Load subfield 352 or the HE BSS Load subfield 354 can be extended to include a BSSID of a given neighbor AP and queue information of the neighbor AP, including L4S / non-L4S queue performance information and/or L4S capability information for the neighbor AP. The BSSID and queue information can be repeated for a number of neighbor APs of the given AP transmitting the enhanced Beacon frame. In some embodiments, a new subfield can be defined for the enhanced Beacon frame 300 in order to advertise queue information for one or more neighbor APs.

Queue information (queue performance information and potentially L4S capability information) provided via enhanced 802.11k Neighbor Reports, enhanced Beacon frames, and/or enhanced Probe Response frames as provided in accordance with embodiments herein can help a STA to select a better roaming candidate AP.

As an example, a wireless client-server pair, such as an AP and STA connected thereto, may have already reduced their bitrate to accommodate L4S congestion at the AP. The STA may be experiencing poor latency-sensitive traffic performance, but all other metrics are normal. Currently, the STA would not use this as a justification to roam. However, when queue performance information, provided in an enhanced 802.11k Neighbor Report, in an enhanced Beacon frame, and/or an enhanced Probe Response frame, is obtained by the STA, the STA can have a clear picture of the L4S and non-L4S queue performance of one or more neighboring APs. The STA now has enough information to make a roaming decision to an AP that could offer better L4S performance (or better predicted performance, for example, if prediction information informs the STA that L4S saturation will continue to get worse over the next x minutes).

In summary, L4S-related information from neighboring APs (including L4S capability support, specific L4S queuing implementation and performance information observed at L4S queues of neighboring APs), can be useful for STAs when making roaming decisions.

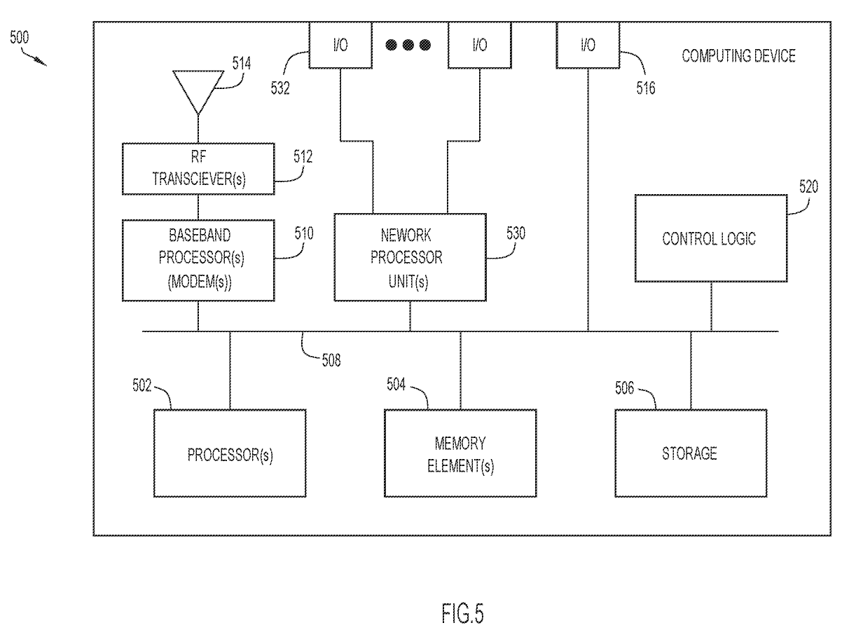

Referring to FIG. 4, FIG. 4 is a flowchart depicting a method 400 according to an example embodiment. In at least one embodiment, method 400 can be performed by an AP of a WLAN, such as any of APs 102-1 – 102-N of system 100.

At 402, the method can include obtaining, by an access point (AP) in a wireless local area network (WLAN), queue information for one or more neighboring APs in the WLAN in which the queue information for each neighboring AP indicates performance of at least one of a plurality of Low Latency, Low Loss, Scalable Throughput (L4S) queues or a plurality of non-L4S queues maintained by each neighboring AP. In some instances, the AP can obtain the queue information for the one or more neighboring APs in the WLAN from the one or more neighboring APs in the WLAN through one or more wired and/or wireless exchanges between the AP and the one or more neighboring APs. In some instances, the AP can obtain the queue information for the one or more neighboring APs in the WLAN from a network controller, for example, through one or more wired and/or wireless exchanges with the network controller.

In various embodiments, the queue information for each neighboring AP includes queue performance information including at least one of: current and/or average queue size or queue depth for at least one of the plurality of L4S queues or the plurality of non-L4S queues; L4S Dual Queue Active Queue Management (AQM) performance parameters including, at least one of an L4S marking probability for the plurality of L4S queues, a queue drop probability for at least one of the plurality of L4S queues or the plurality of non-L4S queues, for at least one of upstream or downstream traffic; queue congestion prediction information for at least one of the plurality of L4S queues or the plurality of non-L4S queues; L4S-related queuing metrics including at least one of real-time delay or throughput performance of the plurality of L4S queues; or timestamp information indicating a Time Synchronization Function (TSF) time of each neighboring AP converted into a TSF time of the AP.

In various embodiments, the queue information for each neighboring AP includes L4S capability information for each neighboring AP including at least one of: an indication, for each neighboring AP, indicating whether L4S queue management is supported; an indication, for each neighboring AP, indicating an L4S queue management type supported; or an indication, for each neighboring AP, indicating whether L4S queue management is supported for at least one of upstream traffic or downstream traffic

At 404, the method can include advertising, by the AP, the queue information for the one or more neighboring APs to at least one wireless device in which the advertising is performed via at least one of a neighbor report, a beacon frame, or a probe response frame.

In various embodiments, the advertising can be performed based on at least one of: a periodic interval, obtaining a request from the wireless device, or predicting that a congestion state for at least one L4S queue including traffic for the wireless device is to satisfy a threshold.

In various embodiments, the queue information is included in at least one of: one or more optional subelement fields of the neighbor report; or one or more reserved bits of a Basic Service Set Identifier (BSSID) information field of the neighbor report. In various embodiments, the queue information is included in a Basic Service Set (BSS) load field or a High Efficiency (HE) BSS load field of the beacon frame or the probe response frame.

In at least one embodiment, the wireless device is caused to roam to a particular neighboring AP based on the queue information advertised by the AP.

Referring to FIG. 5, FIG. 5 illustrates a hardware block diagram of a computing device 500 that may perform functions associated with operations discussed herein in connection with the techniques described for embodiments herein. In various embodiments, a computing device or apparatus, such as computing device 500 or any combination of computing devices 500, may be configured as any entity/entities in order to perform operations of the various techniques discussed for embodiments herein, such as any elements, functions, etc. discussed for embodiments herein (e.g., an AP, a STA, a wireless network controller, etc.).

In at least one embodiment, the computing device 500 may be any apparatus that may include one or more processor(s) 502, one or more memory element(s) 504, storage 506, a bus 508, one or more network processor unit(s) 530 interconnected with one or more network input/output (I/O) interface(s) 532, one or more I/O interface(s) 516, and control logic 520. In various embodiments, instructions associated with logic for computing device 500 can overlap in any manner and are not limited to the specific allocation of instructions and/or operations described herein.

Computing device 500 may further include at least one baseband processor or modem 510, one or more radio RF transceiver(s) 512 (e.g., any combination of RF receiver(s) and RF transmitter(s)), one or more antenna(s) or antenna array(s) 514 (which may be inclusive of software-defined antenna(s) or antenna array(s)) in accordance with embodiments herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa) or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 530 may enable communication between computing device 500 and other systems, entities, etc., via network I/O interface(s) 532 (wired and/or wireless) to facilitate operations discussed for various embodiments described herein. In various embodiments, network processor unit(s) 530 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 532 can be configured as one or more Ethernet port(s), Fibre Channel ports, any other I/O port(s), and/or antenna(s)/antenna array(s) now known or hereafter developed. Thus, the network processor unit(s) 530 and/or network I/O interface(s) 532 may include suitable interfaces for receiving, transmitting, and/or otherwise communicating data and/or information (wired and/or wirelessly) in a network environment.

I/O interface(s) 516 allow for input and output of data and/or information with other entities that may be connected to computing device 500. For example, I/O interface(s) 516 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 512 may perform RF transmission and RF reception of wireless signals via antenna(s)/antenna array(s) 514, and the baseband processor or modem 510 performs baseband modulation and demodulation, etc. associated with such signals to enable wireless communications for computing device 500.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include a method as shown and described herein. In one form an apparatus as shown and described herein is provided. In one form, a system as shown and described herein is provided. In one form, one or more computer readable storage media encoded with software comprising computer executable instructions is/are provided herein that, when the software, is/are executed operable to perform operations as shown and described herein.

In some aspects, the techniques described herein relate to a method including: obtaining, by an access point (AP) in a wireless local area network (WLAN), queue information for one or more neighboring APs in the WLAN, wherein the queue information for each neighboring AP indicates performance of at least one of a plurality of Low Latency, Low Loss, Scalable Throughput (L4S) queues or a plurality of non-L4S queues maintained by each neighboring AP; and advertising, by the AP, the queue information for the one or more neighboring APs to at least one wireless device, wherein the advertising is performed via at least one of a neighbor report, a beacon frame, or a probe response frame.

In some aspects, the techniques described herein relate to a method, wherein the obtaining includes obtaining the queue information from each neighboring AP or obtaining the queue information from a network controller.

In some aspects, the techniques described herein relate to a method, wherein the queue information for each neighboring AP includes queue performance information including at least one of: current and/or average queue size or queue depth for at least one of the plurality of L4S queues or the plurality of non-L4S queues; L4S Dual Queue Active Queue Management (AQM) performance parameters including, at least one of an L4S marking probability for the plurality of L4S queues, a queue drop probability for at least one of the plurality of L4S queues or the plurality of non-L4S queues, for at least one of upstream or downstream traffic; queue congestion prediction information for at least one of the plurality of L4S queues or the plurality of non-L4S queues; L4S-related queuing metrics including at least one of real-time delay or throughput performance of the plurality of L4S queues; or timestamp information indicating a Time Synchronization Function (TSF) time of each neighboring AP converted into a TSF time of the AP.

In some aspects, the techniques described herein relate to a method, wherein the queue information for each neighboring AP includes L4S capability information for each neighboring AP including at least one of: an indication, for each neighboring AP, indicating whether L4S queue management is supported; an indication, for each neighboring AP, indicating an L4S queue management type supported; or an indication, for each neighboring AP, indicating whether L4S queue management is supported for at least one of upstream traffic or downstream traffic.

In some aspects, the techniques described herein relate to a method, wherein the advertising is performed based on at least one of: a periodic interval, obtaining a request from the wireless device, or predicting that a congestion state for at least one L4S queue including traffic for the wireless device is to satisfy a threshold.

In some aspects, the techniques described herein relate to a method, wherein the queue information is included in at least one of: one or more optional subelement fields of the neighbor report; or one or more reserved bits of a Basic Service Set Identifier (BSSID) information field of the neighbor report.

In some aspects, the techniques described herein relate to a method, wherein the queue information is included in a Basic Service Set (BSS) load field or a High Efficiency (HE) BSS load field of the beacon frame or the probe response frame.

In some aspects, the techniques described herein relate to a method, wherein the wireless device is caused to roam to a particular neighboring AP based on the queue information advertised by the AP.

In some aspects, the techniques described herein relate to one or more non-transitory computer readable storage media encoded with instructions that, when executed by a processor, cause the processor to perform operations, including: obtaining, by a first access point (AP) in a wireless local area network (WLAN), queue information for one or more neighboring APs in the WLAN, wherein the queue information for each neighboring AP indicates performance of at least one of a plurality of Low Latency, Low Loss, Scalable Throughput (L4S) queues or a plurality of non-L4S queues maintained by each neighboring AP; and advertising, by the AP, the queue information for the one or more neighboring APs to at least one wireless device, wherein the advertising is performed via at least one of a neighbor report, a beacon frame, or a probe response frame.

In some aspects, the techniques described herein relate to a media, wherein the obtaining includes obtaining the queue information from each neighboring AP or obtaining the queue information from a network controller.

In some aspects, the techniques described herein relate to a media, wherein the queue information for each neighboring AP includes queue performance information including at least one of: current and/or average queue size or queue depth for at least one of the plurality of L4S queues or the plurality of non-L4S queues; L4S Dual Queue Active Queue Management (AQM) performance parameters including, at least one of an L4S marking probability for the plurality of L4S queues, a queue drop probability for at least one of the plurality of L4S queues or the plurality of non-L4S queues, for at least one of upstream or downstream traffic; queue congestion prediction information for at least one of the plurality of L4S queues or the plurality of non-L4S queues; L4S-related queuing metrics including at least one of real-time delay or throughput performance of the plurality of L4S queues; or timestamp information indicating a Time Synchronization Function (TSF) time of each neighboring AP converted into a TSF time of the AP.

In some aspects, the techniques described herein relate to a media, wherein the queue information for each neighboring AP includes L4S capability information for each neighboring AP including at least one of: an indication, for each neighboring AP, indicating whether L4S queue management is supported; an indication, for each neighboring AP, indicating an L4S queue management type supported; or an indication, for each neighboring AP, indicating whether L4S queue management is supported for at least one of upstream traffic or downstream traffic.

In some aspects, the techniques described herein relate to a media, wherein the advertising is performed based on at least one of: a periodic interval, obtaining a request from the wireless device, or predicting that a congestion state for at least one L4S queue including traffic for the wireless device is to satisfy a threshold.

In some aspects, the techniques described herein relate to a media, wherein the queue information is included in at least one of: one or more optional subelement fields of the neighbor report; one or more reserved bits of a Basic Service Set Identifier (BSSID) information field of the neighbor report; or a Basic Service Set (BSS) load field or a High Efficiency (HE) BSS load field of the beacon frame or the probe response frame.

In some aspects, the techniques described herein relate to an access point (AP) in a wireless local area network (WLAN), the AP including: at least one memory element for storing data; and at least one processor for executing instructions associated with the data, wherein executing the instructions causes the AP to perform operations, including: obtaining, by the AP, queue information for one or more neighboring APs in the WLAN, wherein the queue information for each neighboring AP indicates performance of at least one of a plurality of Low Latency, Low Loss, Scalable Throughput (L4S) queues or a plurality of non-L4S queues maintained by each neighboring AP; and advertising, by the AP, the queue information for the one or more neighboring APs to at least one wireless device, wherein the advertising is performed via at least one of a neighbor report, a beacon frame, or a probe response frame.

In some aspects, the techniques described herein relate to an AP, wherein the obtaining includes obtaining the queue information from each neighboring AP or obtaining the queue information from a network controller.

In some aspects, the techniques described herein relate to a AP, wherein the queue information for each neighboring AP includes queue performance information including at least one of: current and/or average queue size or queue depth for at least one of the plurality of L4S queues or the plurality of non-L4S queues; L4S Dual Queue Active Queue Management (AQM) performance parameters including, at least one of an L4S marking probability for the plurality of L4S queues, a queue drop probability for at least one of the plurality of L4S queues or the plurality of non-L4S queues, for at least one of upstream or downstream traffic; queue congestion prediction information for at least one of the plurality of L4S queues or the plurality of non-L4S queues; L4S-related queuing metrics including at least one of real-time delay or throughput performance of the plurality of L4S queues; or timestamp information indicating a Time Synchronization Function (TSF) time of each neighboring AP converted into a TSF time of the AP.

In some aspects, the techniques described herein relate to a AP, wherein the queue information for each neighboring AP includes L4S capability information for each neighboring AP including at least one of: an indication, for each neighboring AP, indicating whether L4S queue management is supported; an indication, for each neighboring AP, indicating an L4S queue management type supported; or an indication, for each neighboring AP, indicating whether L4S queue management is supported for at least one of upstream traffic or downstream traffic.

In some aspects, the techniques described herein relate to an AP, wherein the advertising is performed based on at least one of: a periodic interval, obtaining a request from the wireless device, or predicting that a congestion state for at least one L4S queue including traffic for the wireless device is to satisfy a threshold.

In some aspects, the techniques described herein relate to a AP, wherein the queue information is included in at least one of: one or more optional subelement fields of the neighbor report; one or more reserved bits of a Basic Service Set Identifier (BSSID) information field of the neighbor report; or a Basic Service Set (BSS) load field or a High Efficiency (HE) BSS load field of the beacon frame or the probe response frame.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, by an access point (AP) in a wireless local area network (WLAN), queue information for one or more neighboring APs in the WLAN, wherein the queue information for each neighboring AP indicates performance of at least one of a plurality of Low Latency, Low Loss, Scalable Throughput (L4S) queues or a plurality of non-L4S queues maintained by each neighboring AP; and
advertising, by the AP, the queue information for the one or more neighboring APs to at least one wireless device, wherein the advertising is performed via at least one of a neighbor report, a beacon frame, or a probe response frame.

2. The method of claim 1, wherein the obtaining includes obtaining the queue information from each neighboring AP or obtaining the queue information from a network controller.

3. The method of claim 1, wherein the queue information for each neighboring AP includes queue performance information including at least one of:
current and/or average queue size or queue depth for at least one of the plurality of L4S queues or the plurality of non-L4S queues;
L4S Dual Queue Active Queue Management (AQM) performance parameters including, at least one of an L4S marking probability for the plurality of L4S queues, a queue drop probability for at least one of the plurality of L4S queues or the plurality of non-L4S queues, for at least one of upstream or downstream traffic;
queue congestion prediction information for at least one of the plurality of L4S queues or the plurality of non-L4S queues;
L4S-related queuing metrics including at least one of real-time delay or throughput performance of the plurality of L4S queues; or
timestamp information indicating a Time Synchronization Function (TSF) time of each neighboring AP converted into a TSF time of the AP.

4. The method of claim 1, wherein the queue information for each neighboring AP includes L4S capability information for each neighboring AP including at least one of:
an indication, for each neighboring AP, indicating whether L4S queue management is supported;
an indication, for each neighboring AP, indicating an L4S queue management type supported; or
an indication, for each neighboring AP, indicating whether L4S queue management is supported for at least one of upstream traffic or downstream traffic.

5. The method of claim 1, wherein the advertising is performed based on at least one of: a periodic interval, obtaining a request from the at least one wireless device, or predicting that a congestion state for at least one L4S queue including traffic for the at least one wireless device is to satisfy a threshold.

6. The method of claim 1, wherein the queue information is included in at least one of:
one or more optional subelement fields of the neighbor report; or
one or more reserved bits of a Basic Service Set Identifier (BSSID) information field of the neighbor report.

7. The method of claim 1, wherein the queue information is included in a Basic Service Set (BSS) load field or a High Efficiency (HE) BSS load field of the beacon frame or the probe response frame.

8. The method of claim 1, wherein the at least one wireless device is caused to roam to a particular neighboring AP based on the queue information advertised by the AP.

9. One or more non-transitory computer readable storage media encoded with instructions that, when executed by a processor, cause the processor to perform operations, comprising:
obtaining, by a first access point (AP) in a wireless local area network (WLAN), queue information for one or more neighboring APs in the WLAN, wherein the queue information for each neighboring AP indicates performance of at least one of a plurality of Low Latency, Low Loss, Scalable Throughput (L4S) queues or a plurality of non-L4S queues maintained by each neighboring AP; and
advertising, by the AP, the queue information for the one or more neighboring APs to at least one wireless device, wherein the advertising is performed via at least one of a neighbor report, a beacon frame, or a probe response frame.

10. The media of claim 9, wherein the obtaining includes obtaining the queue information from each neighboring AP or obtaining the queue information from a network controller.

11. The media of claim 9, wherein the queue information for each neighboring AP includes queue performance information including at least one of:
current and/or average queue size or queue depth for at least one of the plurality of L4S queues or the plurality of non-L4S queues;
L4S Dual Queue Active Queue Management (AQM) performance parameters including, at least one of an L4S marking probability for the plurality of L4S queues, a queue drop probability for at least one of the plurality of L4S queues or the plurality of non-L4S queues, for at least one of upstream or downstream traffic;
queue congestion prediction information for at least one of the plurality of L4S queues or the plurality of non-L4S queues;
L4S-related queuing metrics including at least one of real-time delay or throughput performance of the plurality of L4S queues; or
timestamp information indicating a Time Synchronization Function (TSF) time of each neighboring AP converted into a TSF time of the AP.

12. The media of claim 9, wherein the queue information for each neighboring AP includes L4S capability information for each neighboring AP including at least one of:
an indication, for each neighboring AP, indicating whether L4S queue management is supported;
an indication, for each neighboring AP, indicating an L4S queue management type supported; or
an indication, for each neighboring AP, indicating whether L4S queue management is supported for at least one of upstream traffic or downstream traffic.

13. The media of claim 9, wherein the advertising is performed based on at least one of: a periodic interval, obtaining a request from the at least one wireless device, or predicting that a congestion state for at least one L4S queue including traffic for the at least one wireless device is to satisfy a threshold.

14. The media of claim 9, wherein the queue information is included in at least one of:
one or more optional subelement fields of the neighbor report;
one or more reserved bits of a Basic Service Set Identifier (BSSID) information field of the neighbor report; or
a Basic Service Set (BSS) load field or a High Efficiency (HE) BSS load field of the beacon frame or the probe response frame.

15. An access point (AP) in a wireless local area network (WLAN), the AP comprising:
at least one memory element for storing data; and
at least one processor for executing instructions associated with the data, wherein executing the instructions causes the AP to perform operations, comprising:
obtaining, by the AP, queue information for one or more neighboring APs in the WLAN, wherein the queue information for each neighboring AP indicates performance of at least one of a plurality of Low Latency, Low Loss, Scalable Throughput (L4S) queues or a plurality of non-L4S queues maintained by each neighboring AP; and
advertising, by the AP, the queue information for the one or more neighboring APs to at least one wireless device, wherein the advertising is performed via at least one of a neighbor report, a beacon frame, or a probe response frame.

16. The AP of claim 15, wherein the obtaining includes obtaining the queue information from each neighboring AP or obtaining the queue information from a network controller.

17. The AP of claim 15, wherein the queue information for each neighboring AP includes queue performance information including at least one of:
current and/or average queue size or queue depth for at least one of the plurality of L4S queues or the plurality of non-L4S queues;
L4S Dual Queue Active Queue Management (AQM) performance parameters including, at least one of an L4S marking probability for the plurality of L4S queues, a queue drop probability for at least one of the plurality of L4S queues or the plurality of non-L4S queues, for at least one of upstream or downstream traffic;
queue congestion prediction information for at least one of the plurality of L4S queues or the plurality of non-L4S queues;
L4S-related queuing metrics including at least one of real-time delay or throughput performance of the plurality of L4S queues; or
timestamp information indicating a Time Synchronization Function (TSF) time of each neighboring AP converted into a TSF time of the AP.

18. The AP of claim 15, wherein the queue information for each neighboring AP includes L4S capability information for each neighboring AP including at least one of:
an indication, for each neighboring AP, indicating whether L4S queue management is supported;
an indication, for each neighboring AP, indicating an L4S queue management type supported; or
an indication, for each neighboring AP, indicating whether L4S queue management is supported for at least one of upstream traffic or downstream traffic.

19. The AP of claim 15, wherein the advertising is performed based on at least one of: a periodic interval, obtaining a request from the at least one wireless device, or predicting that a congestion state for at least one L4S queue including traffic for the at least one wireless device is to satisfy a threshold.

20. The AP of claim 15, wherein the queue information is included in at least one of:
one or more optional subelement fields of the neighbor report;
one or more reserved bits of a Basic Service Set Identifier (BSSID) information field of the neighbor report; or
a Basic Service Set (BSS) load field or a High Efficiency (HE) BSS load field of the beacon frame or the probe response frame.
